(19) United States
(12) Patent Application Publication
(10) Pub. No.: US 2010/0164905 A1
(43) Pub. Date: Jul. 1, 2010

(54) METHOD OF IMPROVED COMPUTATION OF TOUCH COORDINATES FOR FOUR-WIRE RESISTIVE TOUCH SCREENS

(75) Inventors: Boon Loong Woo, Singapore (SG); Gopalakrishnan Srinivasan, Singapore (SG)

Correspondence Address: STMICROELECTRONICS, INC., MAIL STATION 2346, 1310 ELECTRONICS DRIVE, CARROLLTON, TX, 75006, US

(73) Assignee: STMICROELECTRONICS ASIA PACIFIC PTE, LTD., Singapore (SG)

(21) Appl. No.: 12/649,106

(22) Filed: Dec. 29, 2009

Related U.S. Application Data
(60) Provisional application No. 61/141,186, filed on Dec. 29, 2008.

(51) Int. Cl. G06F 3/045

(52) U.S. Cl. 345/174

(57) ABSTRACT

A method for calculating coordinates and touch pressure on a four-wire resistive touch screen includes applying a voltage gradient across a flexible resistive sheet in a touch screen and measuring the voltage where the screen comes in contact with another screen via analog to digital couplings to the other screen. The touch pressure is acquired by applying a higher voltage potential to one resistive sheet and a lower voltage potential to the other sheet so that current flows between the sheets at the point of contact between the sheets. A voltage on each sheet is then measured at the point of contact shared by the sheets. The measured voltages are used to calculate the touch pressure.

### BACKGROUND

1. Technical Field

This invention generally relates to the field of resistive touch screens.

2. Description of the Related Art

Resistive touch screens are commonly used electronic devices. They are used in a variety of applications including mobile phones, personal digital assistants, point-of-sale machines, kiosks, etc. A resistive touch screen, as shown in FIG. 1A, provides an input interface to a user who can press the touch screen using, for example, a stylus or the user's finger, even if the finger is gloved. Resistive touch screens are designed to operate with resilience to abrasion and insensitivity to dust, humidity, water droplets, moisture, radio frequency interference, and electromagnetic interference.

FIG. 1B shows a cut-away side view of a stylus pressing a resistive touch screen 3. It also illustrates components generally found in resistive touch screen 3. Resistive touch screen 3 includes a protective layer 4, an upper sheet 6, an electrode bar 8, a wire connection 10, an electrode bar 12, wire connection 14, separation beads 16, lower sheet 18, wire connection 20, and substrate 21.

A touch location 1, the point at which the screen is pressed, can be detected and determined while upper sheet 6 is in contact with lower sheet 18. Upper sheet 6 and lower sheet 18 are flexible sheets made from, or coated with, a resistive material. When upper sheet 6 is pressed upon, the sheet flexes between separation beads 16 and makes contact with lower sheet 18 at touch location 1. Touch location 1 can then be determined using the wires coupled to the upper and lower sheets.

FIG. 2A shows a top view 5 of upper sheet 6. Upper sheet 6 represents the resistances along an x-axis of the resistive touch screen. Top view 5 illustrates a resistance 22 existing between electrode bar 8 and touch location 1. The closer touch location 1 is to electrode bar 8, the smaller the value of resistance 22 will be. Top view 5 also illustrates a resistance 24 existing between electrode bar 12 and touch location 1.

The illustrated resistances are meaningful when a voltage is applied across upper sheet 6. Wires 10 and 14 are coupled to electrode bars 8 and 12, respectively. Electrode bars 8 and 12 distribute a uniform, unidirectional voltage gradient across the width of upper screen 6. Voltage drops across resistances 22 and 24 can then be used to find touch location 1 along a single axis by relating decrease in voltage potential to distance from the voltage source.

FIG. 2B shows a top view 7 of lower sheet 18. Lower sheet 18 represents the resistances along a y-axis of the resistive touch screen. Top view 7 illustrates a resistance 30 existing between electrode bar 26 and touch location 1. The closer touch location 1 is to electrode bar 26, the smaller the value of resistance 30 will be. Top view 5 also illustrates a resistance 32 existing between electrode bar 19 and touch location 1.

FIG. 2C shows a top view 9 representing the overlay of upper sheet 6 upon lower sheet 18. As shown in the figure, the four resistances commonly terminate at touch location 1 but extend independently to their respective electrode bars.

FIG. 2D shows an exploded isometric view 11 of resistive touch screen 3. This view illustrates the relationship of a touch resistance 25 to upper sheet 6 and lower sheet 18. Touch resistance 25 will vary with the amount and type of pressure applied at touch location 1. Touch resistance 25 will typically be higher when produced by a soft press or a press by a blunter object, such as a finger. The resistance will typically be lower in when produced by a firm press or a press by a sharper object, such as a stylus tip. Determining touch resistance 25 is a way of quantifying the pressure applied at touch location 1.

A few conventional approaches are used for acquiring touch location 1 and touch pressure on a resistive touch screen. The simplest solution is to drive and measure the four corresponding wires of the touch screen. The measured values correspond directly to the X and Y coordinates. The touch pressure can be computed based on the coordinates and touch resistance 25. If a 12-bit analog-to-digital converter (“ADC”) is employed, for example, the touch screen has a resolution of 4096 in each of the X and Y coordinates. Unfortunately, potential differences in voltage levels between the ADC reference inputs and the touch screen driving voltage may result in measured coordinates that do not accurately reflect the true coordinates of the touch.

A conventional approach used to compensate for the discrepancy between measured and actual touch location coordinates is to make the ADC reference inputs the same as the touch screen panel driving voltage. Accordingly, the measured coordinates should be equivalent to the actual touch coordinates. This approach, however, requires the touch screen drivers to be enabled as long as the ADC is performing coordinate measurement, including signal acquisition and conversion. This unavoidably results in higher power consumption, especially in the case when the analog-to-digital conversion is slow.

Another conventional approach is to use the internal ADC reference only. This approach requires the measurement of additional points on the touch screen to provide Vₘₐₓ (output of the buffer driving high), Vₘᵢₙ (output of the buffer driving low), and V_{raw} (measured coordinate). A processor is typically employed to normalize the measured coordinates to the full-scale resolution, as expressed by: [(V_{raw}−Vₘᵢₙ)/(Vₘₐₓ−Vₘᵢₙ)]×(number of pixels). The drawback of this approach is that it requires a powerful processor to perform the computation, and it is very slow to perform the recognition.

In summary, several approaches have been attempted to accurately read touch coordinates on a four-wire resistive touch screen. However, each of these approaches has particular shortcomings.

### BRIEF SUMMARY

In one embodiment, the X and Y coordinates of a touch location on a resistive touch screen are acquired. The X coordinate is acquired by first applying a voltage gradient across an upper sheet, the upper sheet representing the x-axis. The voltage potential on the upper sheet decreases linearly from the side where an upper voltage potential is applied to the side where a lower voltage potential, or ground, is applied. Next, a voltage potential on the upper sheet at the touch location is measured with the lower sheet through a point of contact between the upper sheet and a lower sheet. The point of contact arises from the upper sheet being pressed onto the lower sheet at the touch location. The lower sheet uses a coupling to an analog-to-digital converter (“ADC”) to measure the voltage potential. The measured voltage potential is converted to a numerical figure representing a position on an x-axis imaginarily superimposed onto the touch screen. In one embodiment the ADC is a 12-bit device so the resolution of the x-axis is 4096 counts or pixels.

The Y coordinate is acquired in a manner similar to the X coordinate. While a voltage is not being applied across the upper sheet, a voltage gradient is applied across the lower sheet, the lower sheet representing the y-axis. A voltage potential on the lower sheet, at the touch location, is measured with the upper sheet through the point of contact between the upper sheet and lower sheet. The voltage potential is measured through a coupling between the upper sheet and the ADC. The measurement is then converted to a numerical figure representing a position on a y-axis imaginarily superimposed onto the touch screen. In one embodiment the ADC is a 12-bit device so the resolution of the y-axis is 4096 counts or pixels.

In another embodiment, a touch pressure at the touch location is acquired by a different technique. First, a higher voltage potential is applied to one side of the upper sheet, and a lower voltage potential, or ground, is applied to one side of the lower sheet. The difference in voltage potential between the upper and lower sheets, the Y coordinate, and the total resistance of the lower plate are used to calculate the touch resistance. The touch pressure applied at the touch location is then inversely proportional to the determined touch resistance, i.e., increases in touch pressure results in lower touch resistance. In one embodiment, the lower voltage potential is applied to the side of the lower sheet that is furthest from the touch location.

Acquiring the coordinates of a touch location on a resistive touch screen in accordance with an embodiment of this invention has several advantages over previous approaches. One advantage is that only three wires of the four wire touch screen are being used at any one time to acquire a coordinate or a touch pressure. Another advantage is that the computations comprise simple addition, division, and subtraction, and therefore do not require powerful processing to complete the computations. Whereas previous methods of acquiring the touch coordinates included driving all four wires and reading all four wires, the present method of driving only two wires at any given time has the additional advantage of lower power dissipation. Furthermore, making three measurements from an analog to digital conversion module versus four measurements has the advantage of executing fewer computations, resulting in less data to propagate through the memory buffers. In accordance with an embodiment of the invention, only four inputs of an analog to digital converter are used to operate a four-wire touch screen, thereby allowing the other ADC inputs to be allocated to other computational resources.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale.

FIG. 1A shows an illustration of a known four-wire resistive touch screen.

FIG. 1B shows a side view cut away illustration of a prior art four-wire resistive layer touch screen.

FIG. 2A shows a top view of the upper resistive sheet in isolation.

FIG. 2B shows a top view of the lower resistive sheet in isolation.

FIG. 2C shows a top view of the upper resistive sheet overlying the lower resistive sheet, from FIG. 1B.

FIG. 2D shows an exploded isometric view of a four-wire resistive touch screen, from FIG. 1B.

FIG. 3 shows a schematic of a touch screen coupled to a touch screen controller, in accordance with an embodiment of the invention.

FIG. 4A shows a schematic of a touch screen controller acquiring an X coordinate of a touch location, in accordance with an embodiment of the invention.

FIG. 4B shows a schematic of a touch screen controller acquiring a Y coordinate of a touch location, in accordance with an embodiment of the invention.

FIGS. 5A and 5B show schematics of touch screen controller configurations to acquire the touch pressure on a touch screen at a touch location, in accordance with an embodiment of the invention.

FIG. 6A is a flow diagram illustrating a method for acquiring X and Y coordinates on a four-wire resistive touch screen, in accordance with an embodiment of the invention.

FIG. 6B is a flow diagram illustrating a method for calculating touch pressure at a touch location on a four-wire resistive touch screen, in accordance with an embodiment of the invention.

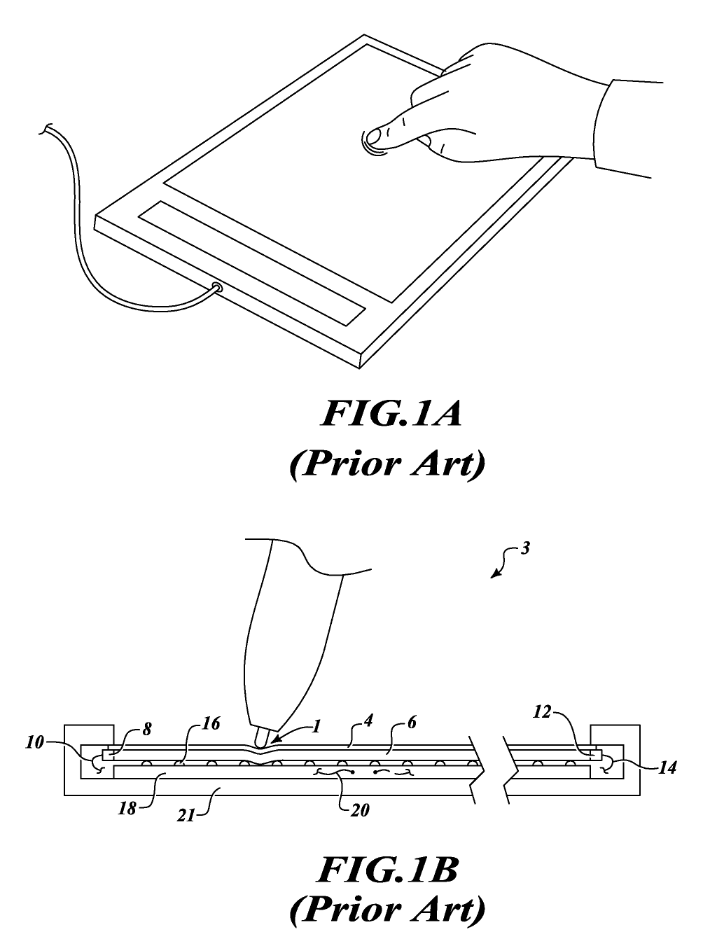

### DETAILED DESCRIPTION

Touch screen interfaces fulfill roles in various markets. In the mobile market, touch screens can be found in devices such as mobile phones, and personal digital assistants. In the heavy commercial market, assisted touch screens can be found in devices such as ATM machines and gaming machines. In the home market, touch screens can be found in applications such interactive personal computer monitors. The numerous applications in which touch screens are used make touch screen speed and accuracy of growing importance and concern.

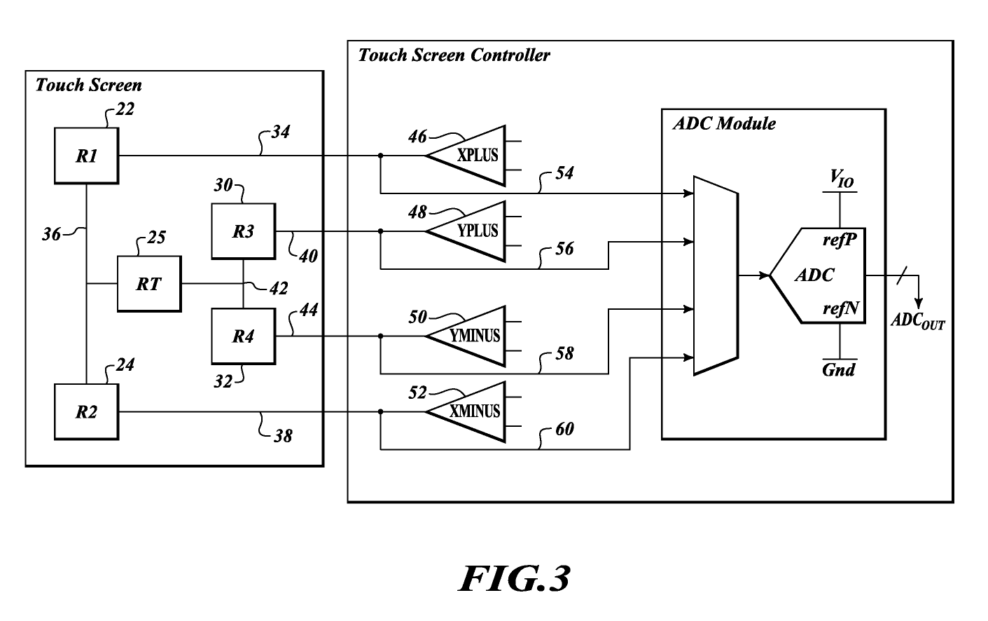

FIG. 3 illustrates a schematic of a touch screen controller coupled to a touch screen in a configuration to acquire an X coordinate, a Y coordinate, and touch pressure. The schematic of the touch screen includes node 34, resistance 22, node 36, resistance 24, and node 38 of the x-axis flexible sheet. The touch screen schematic also includes node 40, resistance 30, node 42, resistance 32, and node 44 of the y-axis sheet. Touch resistance 25 represents the resistance between the x-axis sheet and the y-axis sheet at a touch location. The touch screen controller includes XPLUS driver 46, node 54, YPLUS driver 48, node 56, YMINUS driver 50, node 58, XMINUS driver 52, node 60, and an analog to digital converter (“ADC”) module.

Applying voltage potentials to the x-axis and y-axis sheets enables the touch screen controller to measure voltages at various locations on the touch screen. The four drivers XPLUS driver 46, YPLUS driver 48, YMINUS driver 50, and XMINUS driver 52 selectively apply high and low voltage potentials to the nodes coupling the drivers to the touch screen. In one embodiment, the drivers are implemented as analog output drivers. Each driver may apply a high or a low voltage potential to the node it is coupled to when the driver is enabled. When any driver is disabled, its output is floating and neither sinks nor sources current.

Four inputs of the ADC module are used to acquire measurements from the nodes coupling the output drivers to the touch screen. In one embodiment, the ADC module has 8 inputs, so four inputs are free to perform sampling and conversion on other channels not connected to the four-wire touch screen. The ADC is therefore has its multiple channels multiplexed. Nodes 54 and 60 couple nodes 34 and 38 to inputs on the ADC module for x-axis sheet 6. Nodes 34 and 38 represent couplings to the electrode bars located on two ends of x-axis upper sheet 6. Nodes 56 and 58 couple nodes 40 and 44 to the ADC for y-axis sheet 18. Nodes 40 and 44 represent couplings to the electrode bars located on two ends of the y-axis lower sheet 18. The ADC module is capable of measuring the voltage potential at nodes 34, 38, 40, and 44 independent of whether an output driver coupled to that node is driving a voltage or floating. In one embodiment, the ADC connections to the output drivers are made inside the touch screen controller. In another embodiment, the ADC connections are made to the output drivers outside of the touch screen controller.

The ADC has its own internal reference voltages. The reference voltages of the ADC may differ in value from the voltages applied to the output drivers. By default the ADC applies its internal reference voltages to an analog signal it is converting; therefore a mismatch in reference voltages may produce erroneous ADC outputs. In one embodiment, the ADC is calibrated by being configured with an upper voltage potential and a lower voltage potential in prior to converting a voltage potential to a digital signal.

The touch screen controller converts measured voltages to numeric values using the ADC module. The ADC module converts voltages measured on its inputs to a count. The count is dependent upon the number of bits on the output of the ADC module. The range of the count is zero to 2ⁿ−1, where n is the number of bits of the ADC. In one embodiment, the ADC module is constructed with a 12-bit ADC. In another embodiment, the ADC of the ADC module is a multi analog input channel device implemented as a successive approximation register (“SAR”) ADC to allow other ADC input channels to perform sampling and conversion at the same time.

As an example of how an ADC converts a voltage to a count, consider a 2-bit ADC tasked with converting a measurement in a voltage range of 0V to 10 V. Since the ADC only has available output counts of 0, 1, 2, and 3, a measurement from 0 V to approximately 2.5 V would be assigned a count of 0. A measurement in the range of 2.5 V to approximately 5 V would be assigned a count of 1, and so forth. Hence, the output count depends upon the measured voltage, the range of measurements available, and the size, in bits, of the ADC.

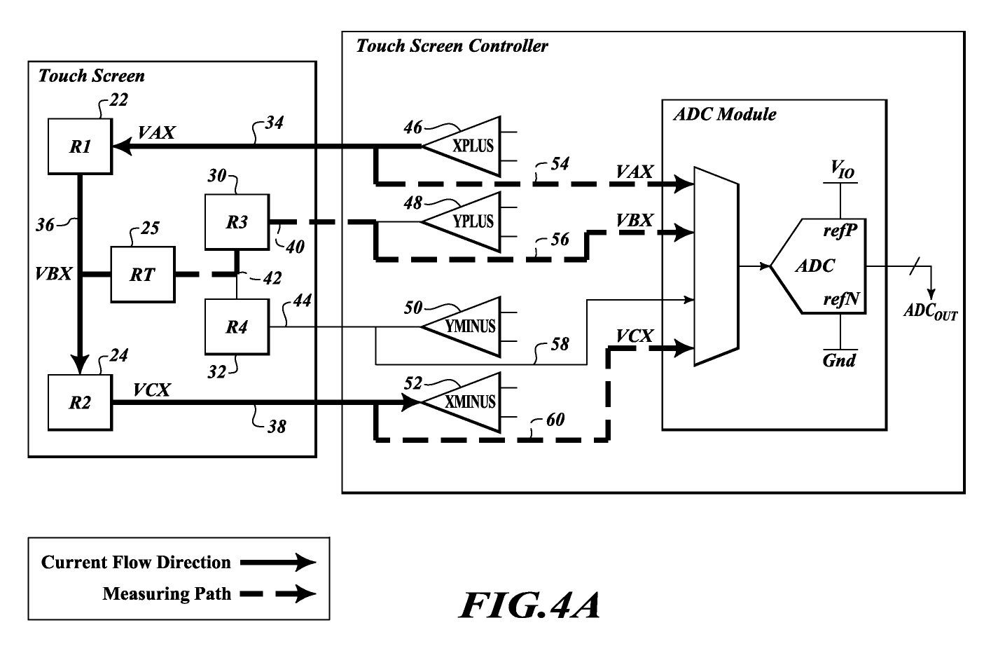

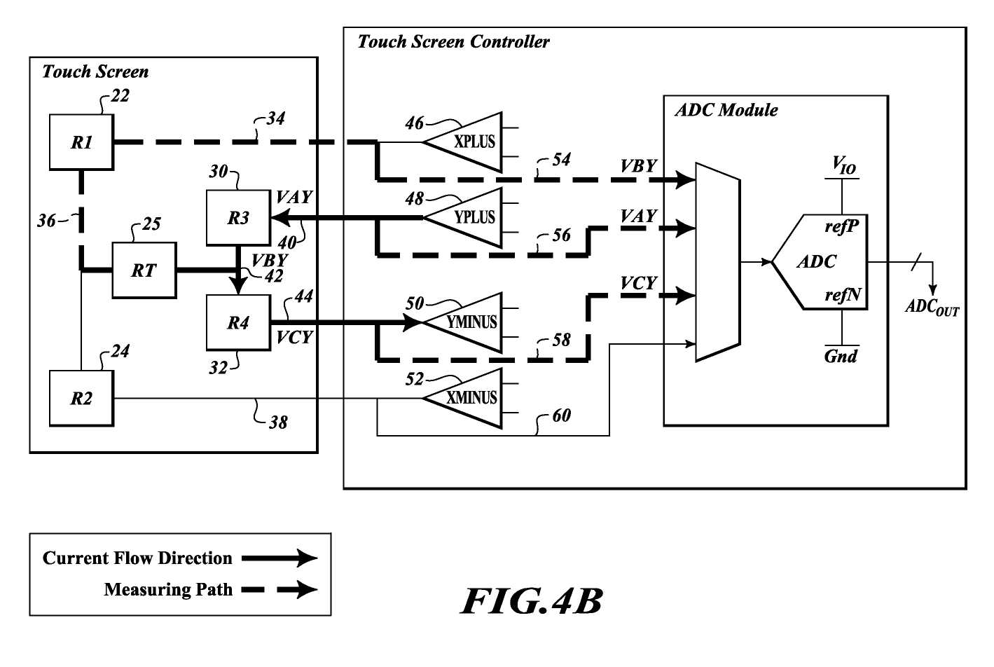

FIG. 4A illustrates a configuration of the touch screen controller to acquire an X coordinate of touch location 1 from the touch screen, in accordance with an embodiment of the invention. While no voltage is applied to y-axis lower sheet 18, XPLUS driver 46 applies a high voltage potential, e.g. 3.3 V, to node 34, and XMINUS driver 52 applies a low voltage potential, e.g. 0 V, to node 38. This effectively applies a uniform voltage gradient across x-axis upper sheet 6.

The touch screen controller next measures the voltage potentials at node 34, node 36, and node 38. Because the reference voltages of the output drivers may differ from reference voltages of the ADC module, measuring node 34 voltage VAX and node 38 voltage VCX enables the ADC module to utilize the full-scale output of the ADC. The node 36 voltage VBX is a product of a voltage divider characterized by the resistance 22 and resistance 24. As such,

$$VBX = ( VAX - VCX ) \frac{R 2}{R 1 + R 2} + VCX .$$

Node 36 voltage VBX is measured through y-axis lower sheet 18. During the acquisition of the X coordinate of touch location 1, YPLUS driver 48 and YMINUS driver 50 are not applying a voltage across lower sheet 18, the drivers are floating. Accordingly, when x-axis upper sheet 6 makes contact with y-axis lower sheet 18 at touch location 1, the voltage potential on lower sheet 18 becomes node 36 voltage VBX. Current is neither flowing through touch resistance 25, resistance 30, nor resistance 32, so the voltages at nodes 40, 42, and 44 are all approximately equal to node 36 voltage VBX. Node 56 and node 58 are coupled between the lower sheet 18 and the ADC module, so either node may be used to read node 36 voltage VBX. In one embodiment, node 56 is used to measure the node 36 voltage VBX through the y-axis lower sheet 18.

After node 36 voltage VBX is measured, the voltage may be converted to corresponding X coordinate of touch location 1 on the touch screen.

The ADC module converts the voltage measured to a count, as described previously. If a current I1 flows through upper sheet 6, then the following equations may be applied to obtain the X coordinate. First, by applying Ohms law to resistance 22 (R1) and resistance 24 (R2), we obtain the following expression:

$$VBX = VCX = I 1 \cdot R 2 , \\ VBX - VCX = R 2 \cdot \frac{( VAX - VBX )}{R 1} , \\ \frac{R 2}{R 1} = \frac{VBX - VCX}{VAX - VBX} . \qquad ( equation 1 )$$

Next, by applying the voltage divider principle to the maximum count value of the output of a 12-bit ADC rather than to the maximum voltage applied across x-axis upper sheet 6, we obtain the following expression:

$$X = 4095 \cdot \frac{R 2}{R 1 + R 2} , \\ X = \frac{4095}{( R 1 / R 2 ) + 1} . \qquad ( equation 2 )$$

Substituting equation 1 into equation 2, results in a equation to calculate the X coordinate from voltages VAX, VBX, and VCX:

$$X = \frac{4095}{( ( VAX - VBX ) / ( VBX - VCX ) ) + 1} . \qquad ( equation 3 )$$

As an example of an application of equation 3, consider the state where node 34 voltage VAX is 3.3 V, node 36 voltage VBX is 2.7 V, and node 38 voltage VCX is 0 V. The X coordinate on the touch screen would be approximately,

$$X = \frac{4095}{( ( .6 ) / ( 2.7 ) ) + 1} = 3350 counts . \qquad$$

In the state where VAX<VBX or VBX<VCX, then it is determined that a touch is no longer being detected. As a result, an acquired datum will be discarded. Similarly, the state VAX=VBX and VBX=VCX should not occur, so an acquired datum in this state will be discarded. As can be seen by the discussed equations, for a 12-bit ADC, VAX=VBX and VBX>VCX should produce the maximum X coordinate 4095, and VAX>VBX and VBX VCX should produce the minimum X coordinate 0.

FIG. 4B illustrates a configuration of the touch screen controller to acquire a Y coordinate of touch location 1 from the touch screen, in accordance with an embodiment of the invention. Acquiring a Y coordinate includes steps similar to that of acquiring the X coordinate. First, YPLUS driver 48 and YMINUS driver 50 apply a voltage across y-axis lower sheet 18, while no voltage is applied across upper sheet 6. In one embodiment, YPLUS driver 48 applies a higher voltage potential to node 40, and YMINUS driver 50 applies a lower voltage potential to node 44. Node 40 voltage VAY is measured at the ADC module through node 56, and node 44 voltage VCY is measured at the ADC module through node 58.

The voltage on y-axis lower sheet 18 at touch location 1 is measured through x-axis upper sheet 6. With XPLUS driver 46 and XMINUS driver 52 floating, no current flows through resistance 22, resistance 24, or touch resistance 25. Accordingly, node 42 voltage VBY appears at nodes 34, 36, and 38 by virtue of the contact between x-axis upper sheet 6 and y-axis lower sheet 18 at touch location 1. Node 54 and node 60 are coupled between upper sheet 6 and the ADC module, so either node may be used to read node 42 voltage VBY. In one embodiment, node 54 is used to measure the node 42 voltage VBY through x-axis upper sheet 6.

The Y coordinate can be calculated with equations resembling those used to calculate the X coordinate. If, for example, a current I2 flows through lower sheet 18, then the following equations may be applied to obtain the Y coordinate. First, by applying Ohms law to resistance 30 (R3) and resistance 32 (R4), we obtain the following expression:

$$VBY - VCY = I 2 \cdot R 4 , \\ VBY - VCY = R 4 \cdot \frac{( VAY - VBY )}{R 3} , \\ \frac{R 4}{R 3} = \frac{VBY - VCY}{VAY - VBY} . \qquad ( equation 4 )$$

Next, by applying the voltage divider principle to the maximum count value of the output of a 12-bit ADC, for example, rather than to the maximum voltage applied across y-axis lower sheet 18, we obtain the following expression:

$$Y = 4095 \cdot \frac{R 4}{R 3 + R 4} , \\ Y = \frac{4095}{( R 3 / R 4 ) + 1} . \qquad ( equation 5 )$$

Substituting equation 4 into equation 5, results in a equation to calculate the Y coordinate from voltages VAY, VBY, and VCY:

$$Y = \frac{4095}{( ( VAY - VBY ) / ( VBY - VCY ) ) + 1} . \qquad ( equation 6 )$$

As an example of an application of equation 6, consider the state where node 40 voltage VAY is 3.3 V, node 40 voltage VBY is 1.4 V, and node 42 voltage VCY is 0 V. The Y coordinate on the touch screen would become approximately,

$$Y = \frac{4095}{( ( 1.9 ) / ( 1.4 ) ) + 1} = 1737 counts .$$

In the state where VAY<VBY or VBY<VCY, then it is determined that a touch is no longer being detected. As a result, an acquired datum will be discarded. Similarly, the state VAY=VBY and VBY=VCY should not occur, so an acquired datum in this state will be discarded. As can be seen by the discussed equations, for a 12-bit ADC, VAY=VBY and VBY>VCY should produce the maximum Y coordinate 4095, and VAY>VBY and VBY VCY should produce the minimum Y coordinate 0.

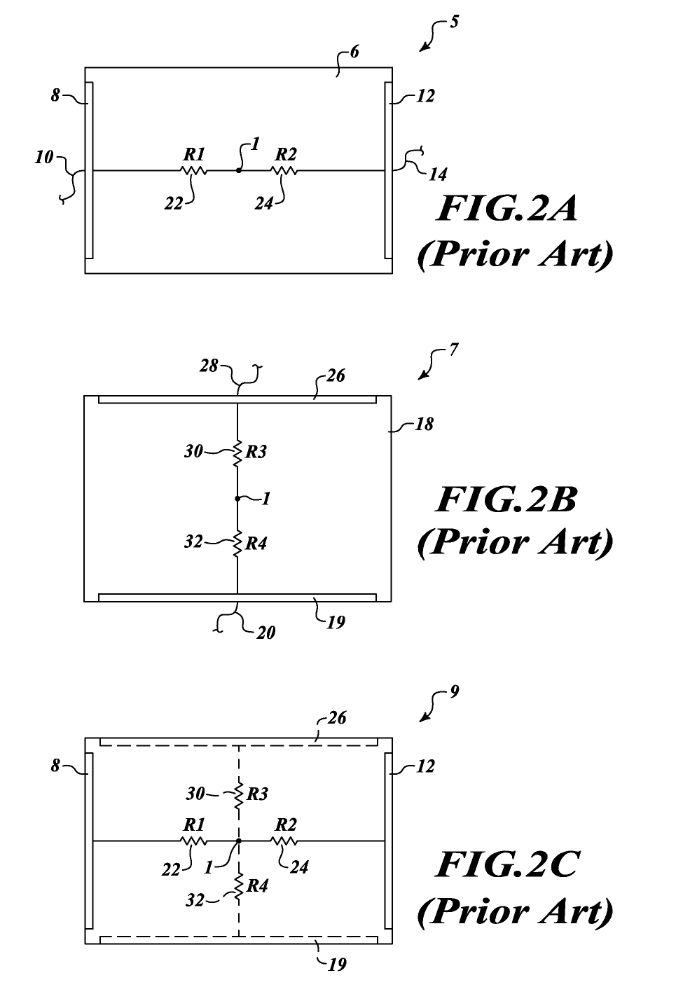

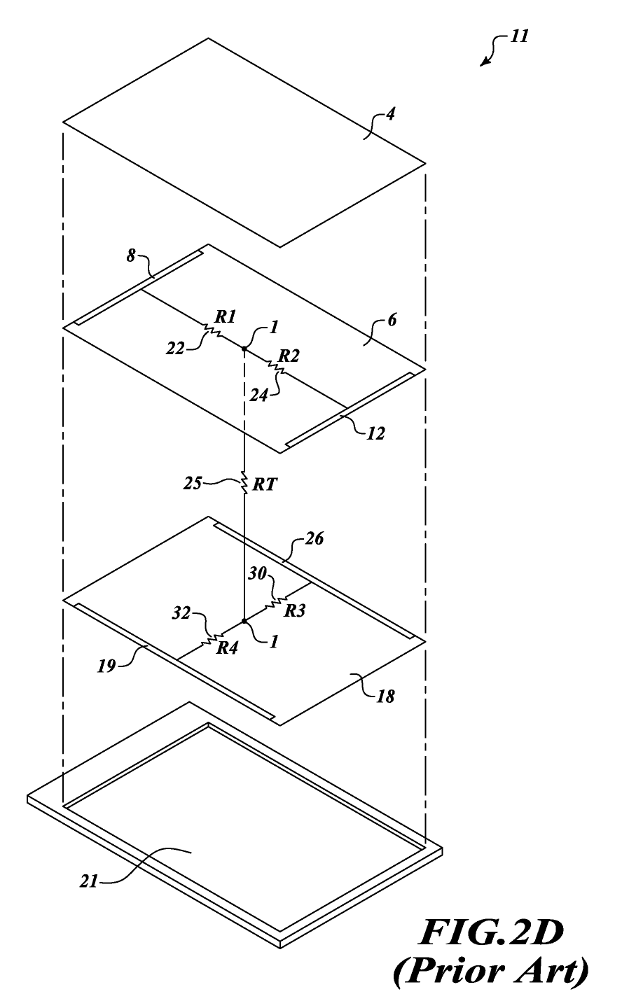

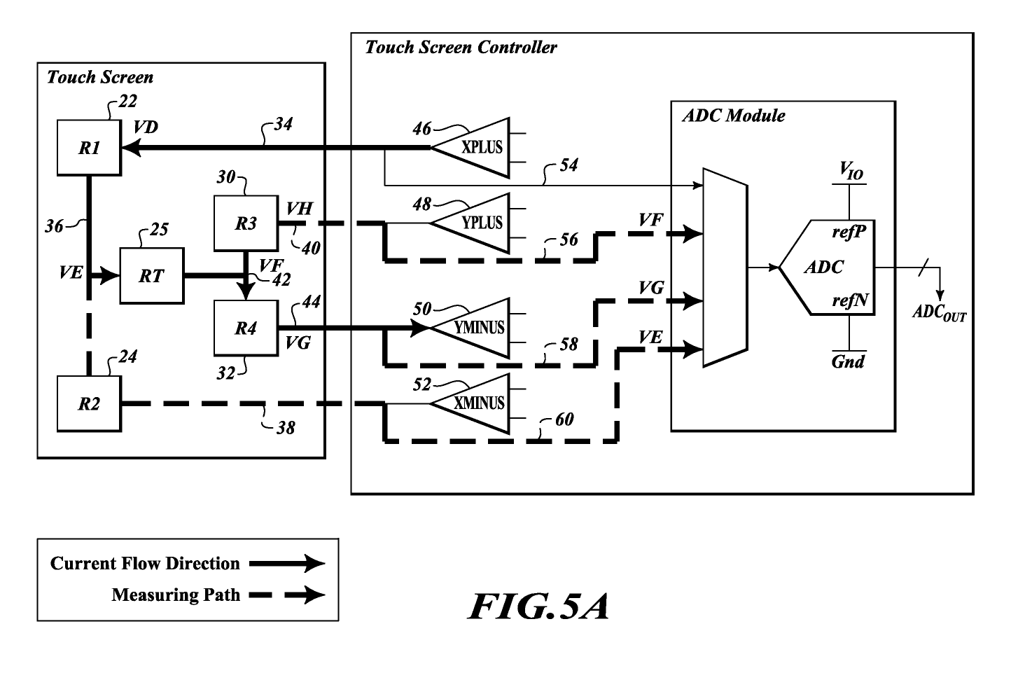

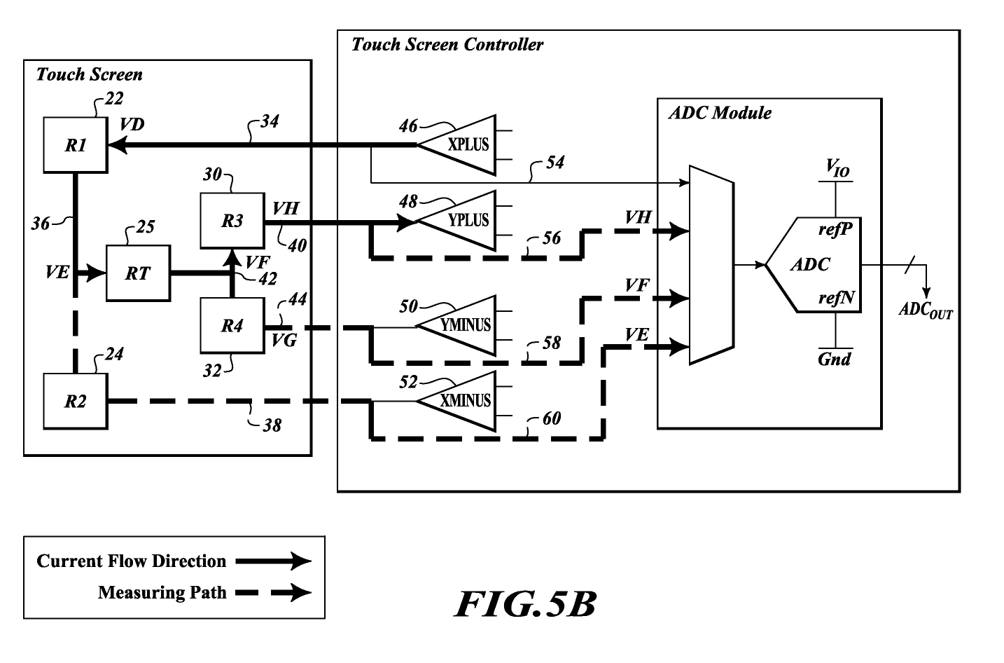

FIGS. 5A and 5B illustrate a configuration for acquiring the touch pressure applied to x-axis upper sheet 6 against y-axis lower sheet 18, in accordance with an embodiment of the invention. The reader is encouraged to reference FIG. 2D when initially following the direction of current flow and measurement paths associated with acquiring the touch pressure. As before, the touch location 1 represents the location on the touch screen where an object has pressed upper sheet 6 against lower sheet 18. The firmer the contact between sheets, the lower the touch resistance 25 will be. In one embodiment, the maximum touch pressure will produces a 0 ohm connection characterized by a 0 V drop from upper sheet 6 to lower sheet 18 at the point of contact. A “no touch” is characterized by a voltage drop equivalent to the difference between the higher voltage potential and lower voltage potential applied to the sheets.

FIG. 5A illustrates a configuration in which a higher voltage potential is applied to one side upper sheet 6, and a lower voltage potential is applied to one side of lower sheet 18 to acquire touch resistance 25. In this configuration, XPLUS driver 46 applies a higher voltage potential to node 34, and YMINUS driver applies a lower voltage potential, e.g. 0 V, to node 44. The subsequent upper sheet voltage drop across resistance 22 results in node 36 voltage VE, and the lower sheet voltage drop across resistance 32 results in node 42 voltage VF.

The non-driving nodes of the upper and lower sheets are used to measure the voltages on either side of touch resistance 25. On upper sheet 6, node 38 is not driven by XMINUS driver 52; the driver output is floating. Because the inputs to the ADC module sink substantially near zero current, no current flows through resistance 24. Consequently, node 36 voltage VE also exists on node 38 and can be measured via node 60 at the ADC module. Similarly, lower sheet 18 has a non-driven node 40 by which node 42 voltage VF may be measured via node 56 at the ADC module.

Having acquired node voltages VE and VF, touch resistance 25 can be calculated using VE, VF, the total resistance of the y-axis lower sheet Rsheet, and the previously acquired Y coordinate. If a touch current IT flows through part of upper sheet 6 and terminates in lower sheet 18, then the following equations may be applied to obtain the touch pressure. Using an exemplary 12-bit ADC maximum count of 4095 and the calculated Y coordinate value (Y), we obtain the following expression for touch resistance 25 (RT):

$$RT = \frac{VE - VF}{IT} , \\ IT = \frac{VF - VG}{R 4} , \\ therefore , \\ RT = \frac{VE - VF}{( VF - VG ) / R 4} . \qquad ( equation 7 )$$

Because the Y coordinate is an expression of the voltage across lower sheet resistance 32 (R4) in comparison to the total resistance of the lower sheet, resistance 32 (R4) may be expressed as:

$$R 4 = \frac{Y \cdot Rsheet}{4095} . \qquad ( equation 8 )$$

Substituting equation 8 into R4 of equation 7 results in an expression for touch resistance in terms of the total lower sheet resistance, the Y coordinate, VE, VF, and VG:

$$RT = \frac{VE - VF}{( VF - VG ) / ( ( Y \cdot Rsheet ) / 4095 )} . \qquad ( equation 9 )$$

Written in another way,

$$RT = \frac{VE - VF}{( VF - VG ) / ( Y / 4095 )} \cdot Rsheet . \qquad ( equation 10 )$$

In one embodiment, the inverse of RT is used to represent the touch pressure. In another embodiment, RT is divided by a constant and inverted to represent the touch pressure.

Some voltage conditions will result in data being discarded. IF VE<VF, then it is determined that a touch is no longer being detected. A similar determination is made if VG>VF or VH>VF.

FIG. 5B illustrates another embodiment of a configuration to measure the touch pressure. In this embodiment, the voltage drop across resistance 30 (R3) is used, rather than the resistance 32 (R4), to acquire node 42 voltage VF. XPLUS driver 46 is used to apply a higher voltage potential to node 34, and YPLUS driver 48 is used to apply a lower voltage potential to lower sheet 18 at node. Accordingly, current flows from XPLUS driver 46 through resistance 22 (R1), touch resistance 25 (RT), and resistance 30 (R3) terminating in YPLUS driver 48. Similar to the configuration shown in FIG. 5A, node 36 voltage VE, node 42 voltage VF, and node 40 voltage VH are measured at the ADC module. Using an exemplary 12-bit ADC maximum count of 4095, touch resistance 25 (RT) is then calculated as follows:

$$RT = \frac{VE - VF}{IT} , \\ IT = \frac{VF - VH}{R 3} , \\ therefore \\ RT = \frac{VE - VF}{( VF - VH ) / R 3} . \qquad ( equation 11 )$$

Because the Y coordinate is an expression of the voltage across lower sheet resistance 32 (R4) in comparison to the total resistance of the lower sheet, resistance 30 (R3) may be expressed using the difference between max count 4095 and the Y coordinate as:

$$R 3 = \frac{( 4095 - Y ) \cdot Rsheet}{4095} . \qquad ( equation 12 )$$

Substituting equation 12 into R3 of equation 11 results in an expression for touch resistance in terms of the total lower sheet resistance, the Y coordinate, VE, VF, and VG

$$RT = \frac{VE - VF}{( VF - VG ) / ( ( ( 4095 - Y ) \cdot Rsheet ) / 4095 )} . \qquad ( equation 13 )$$

Written in another way,

$$RT = \frac{VE - VF}{( VF - VG / ( ( 4095 - Y ) / 4095 )} \cdot Rsheet . \qquad ( equation 14 )$$

In one embodiment, touch resistance 25 is calculated by directing current through the larger of lower sheet resistances 30 (R3) and 32 (R4).

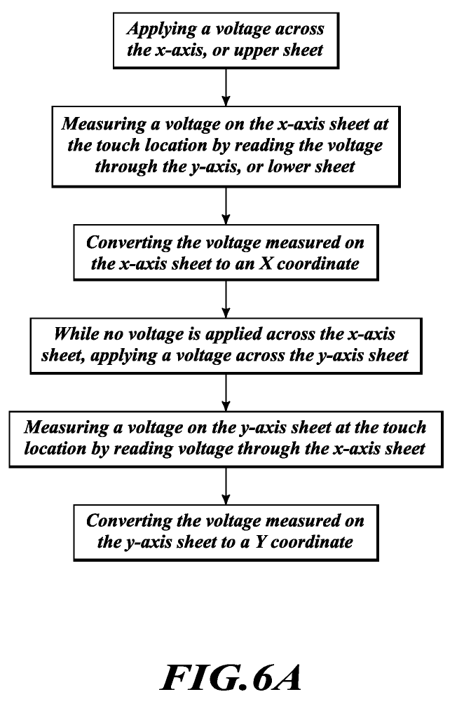

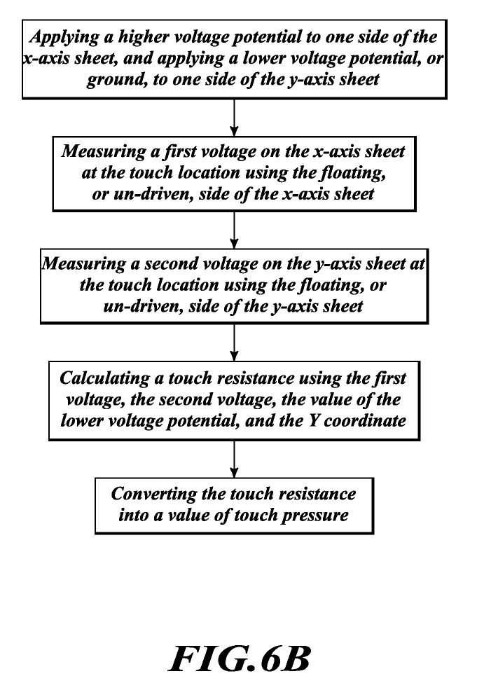

FIG. 6A illustrates a method for acquiring the X and Y coordinates of a touch location 1 on a resistive touch screen, in accordance with an embodiment of the invention. First, a voltage gradient is applied across x-axis upper sheet 6 while no voltage is applied across y-axis lower sheet 18. The voltage is applied to linearly decrease from one electrode to the other. Next, a voltage on upper sheet 6 at touch location 1 is measured through lower sheet 18 via an ADC coupling to the lower sheet. The measured voltage is then converted to an ADC count representing the X coordinate.

The Y coordinate is acquired in a similar manner. First, a voltage is applied across lower sheet 18 while no voltage is applied across x-axis upper sheet 6. Next, a voltage on lower sheet 18 at touch location 1 is measured through upper sheet 6 via an ADC coupling to the upper sheet. Then the measured voltage is converted to an ADC count representing the Y coordinate.

FIG. 6B illustrates a method for acquiring a touch pressure at touch location 1 on a touch screen. First, a higher voltage potential is applied to one side of upper sheet 6 and lower voltage potential is applied to one side of lower sheet 18, resulting in current flowing from the upper sheet down through an inter-sheet point of contact and through part of the lower sheet. A first voltage potential is measured at touch location 1 on upper sheet 6 via the non-driven side of the sheet. A second voltage potential is measured at touch location 1 on lower sheet 18 via the non-driven side of the sheet. Touch resistance 25 is then calculated using the first voltage potential, the second voltage potential, the lower voltage potential, and the Y coordinate. The touch pressure is calculated from touch resistance 25.

In one embodiment, the functions described above are implemented in a single application specific integrated circuit (“ASIC”). The ASIC includes the functionality of a divider, a subtractor, and an adder. In one embodiment, the output drivers are constructed in a single driver module. The drivers of the driver module include PMOS transistors matched with one another and NMOS transistors matched with one another. The voltage drop across the PMOS (VSD) and the voltage drop across the NMOS (VDS) are made as small as possible. In one embodiment, the PMOS and NMOS transistors are constructed to source and sink approximately 50 mA. In another embodiment, the ASIC includes a temperature sensor configured to provide a reference for compensation of various touch screen parameters.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A method of acquiring touch information from a touch screen, comprising:
supplying a first voltage across an upper resistive sheet of the touch screen by using a first voltage source and a second voltage, said voltage sources attached at opposing sides of the upper resistive sheet;
measuring a first voltage potential, the first voltage potential being on the upper resistive sheet at a touched location on the touch screen, the first voltage potential being measured through a contact between the upper resistive sheet and a lower resistive sheet at the touched location using a first coupling between the lower resistive sheet and an analog to digital converter;
calculating a first axis coordinate using the first voltage potential;
supplying a second voltage across the lower resistive sheet of the touch screen by using a third voltage source and a fourth voltage, said voltage sources attached at opposing sides of the lower resistive sheet;
measuring a second voltage potential, the second voltage potential being on the lower resistive sheet of the touch screen at the pressed location, the second voltage potential being measured through the contact between the lower resistive sheet and the upper resistive sheet at the touched location using a first coupling between the upper resistive sheet and the analog to digital converter; and
calculating a second axis coordinate using the second voltage potential.

2. The method of claim 1 wherein the first axis coordinate corresponds to an x-axis and the second axis coordinate corresponds to a y-axis.

3. The method of claim 1 wherein calculating the first axis coordinate includes using measurements of the first and the second voltage sources.

4. The method of claim 1 wherein calculating the second axis coordinate includes using measurements of the third and the fourth voltage sources.

5. The method of claim 1, further including:
applying a high voltage to the upper resistive sheet using the first voltage source;
applying a low voltage to the lower resistive sheet using the fourth voltage source;
measuring a third voltage potential, the third voltage potential being on the upper resistive sheet at the touched location;
measuring a fourth voltage potential, the fourth voltage potential being on the lower resistive sheet at the touched location; and
calculating a resistance of the contact between the upper resistive sheet and the lower resistive using the third voltage potential and the fourth voltage potential.

6. The method of claim 5 wherein measuring the third voltage potential includes using a second coupling between the upper sheet and the analog to digital converter.

7. The method of claim 5 wherein measuring the fourth voltage potential includes using the first coupling between the lower resistive sheet and the analog to digital converter.

8. The method of claim 5 wherein calculating the resistance includes using the total resistance of the lower resistive sheet.

9. The method of claim 5, further including calculating a touch pressure using the resistance of the contact between the upper resistive sheet and the lower resistive sheet.

10. An integrated circuit for reading an x-axis coordinate, a y-axis coordinate, and a touch resistance from a four-wire resistive touch screen, comprising:
a driver module including at least four drivers configurable to source or sink currents in the resistive touch screen;
an analog to digital converter module coupled to the driver module, the analog to digital module including at least four inputs configured to selectively read voltages from a top sheet and a bottom sheet of the resistive touch screen; and
and circuitry configured to calculate the x-axis and y-axis coordinates and the touch resistance of a touch location on the resistive touch screen, the circuitry being configured to calculate the x-axis coordinate by using a voltage at the touch location on the top sheet, the circuitry being further configured to calculate the y-axis coordinate by using a voltage at the touch location on the bottom sheet, the circuitry being further configured to calculate the touch resistance by forcing current to flow from the top sheet through the bottom sheet at the touch location and using voltages induced on each of the top sheet and the bottom sheet at the touch location.

11. The integrated circuit of claim 10, further comprising a temperature sensor configured to provide a reference for compensation of the touch screen parameters.

12. A method, comprising:
driving a first current across an upper resistive plate of a resistive touch screen from a first side of the top resistive sheet to an opposing second side of the top resistive plate;
measuring a first top sheet voltage potential from the first side of the top resistive plate;
measuring a second top sheet voltage potential from the second side of the top resistive sheet;
measuring a third top sheet voltage potential from a bottom resistive sheet at a point of contact between the top resistive sheet and the bottom resistive sheet while no current is driven across the bottom resistive sheet;
producing a first touch coordinate by applying the first top sheet voltage, second top sheet voltage, and third top sheet voltage to an analog to digital converter;
driving a second current across the bottom resistive sheet of the resistive touch screen from a first side of the bottom resistive sheet to an opposing second side of the bottom resistive sheet;
measuring a first bottom sheet voltage from the first side of the bottom resistive sheet;
measuring a second bottom sheet voltage from the second side of the bottom resistive sheet;
measuring a third bottom sheet voltage from the top resistive sheet at the point of contact between the top resistive sheet and the bottom resistive sheet while the first current is not driven across the top resistive sheet; and
producing a second touch coordinate by applying the first bottom sheet voltage, second bottom sheet voltage, and third bottom sheet voltage to an analog to digital converter.

13. The method of claim 12, further including
measuring a touch pressure at the point of contact, wherein measuring the touch pressure comprises:
sourcing a third current from the first side of the top resistive sheet through the point of contact to the bottom resistive sheet and sinking the third current in the bottom resistive sheet;
measuring a first touch voltage at the point of contact on the top resistive sheet, the measuring performed from the second side of the top resistive sheet;
measuring a second touch voltage at the point of contact on the bottom resistive sheet, the measuring performed from the bottom resistive sheet; and
calculating the touch pressure applied at the point of contact using the first touch voltage, and the second touch voltage.

14. The method of claim 13 wherein sinking the third current includes sinking the current on the side of the bottom resistive sheet that is furthest from point of contact.

15. The method of claim 14 wherein measuring the second touch voltage is performed from the side of the bottom resistive sheet that is closest to the point of contact.
